(19) United States
(12) Patent Application Publication
(10) Pub. No.: US 2007/0220367 A1
(43) Pub. Date: Sep. 20, 2007

(54) Fault tolerant computing system

(75) Inventors: Grant L. Smith, Tampa, FL (US); Paul D. Kammann, Plymouth, MN (US); Jason C. Noah, Redington Shores, FL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/348,290

(22) Filed: Feb. 6, 2006

(51) Int. Cl. G06F 11/00

(52) U.S. Cl. 714/48

(57) ABSTRACT

A system for tolerating a single event fault in an electronic circuit is disclosed. The system includes a main processor that controls the operation of the system, a fault detection processor responsive to the main processor, and three or more programmable logic devices responsive to the fault detection processor. The three or more programmable logic devices periodically issue independent input signals to the fault detection processor for determination of one or more single event fault conditions.

### GOVERNMENT INTEREST STATEMENT

The U.S. Government may have certain rights in the present invention as provided for by the terms of a restricted government contract.

### BACKGROUND

Present and future high-reliability (i.e., space) missions require significant increases in on-board signal processing. Presently, generated-data is not transmitted via downlink channels in a reasonable time. As users of the generated data demand faster access, increasingly more data reduction or feature extraction processing is performed directly on the high-reliability vehicle (e.g., spacecraft) involved. Increasing processing power on the high-reliability vehicle provides an opportunity to narrow the bandwidth for the generated data and/or increase the number of independent user channels.

In signal processing applications, traditional instruction-based processor approaches are unable to compete with million-gate, field-programmable gate array (FPGA)-based processing solutions. Systems with multiple FPGA-based processors are required to meet computing needs for Space Based Radar (SBR), next-generation adaptive beam forming, and adaptive modulation space-based communication programs. As the name implies, an FPGA-based system is easily reconfigured to meet new requirements. FPGA-based reconfigurable processing architectures are also re-useable and able to support multiple space programs with relatively simple changes to their unique data interfaces.

Reconfigurable processing solutions come at an economic cost. For instance, existing commercial-off-the-shelf (COTS), synchronous read-only memory (SRAM)-based FPGAs show sensitivity to radiation-induced upsets. Consequently, a traditional COTS-based reconfigurable system approach is unreliable for operating in high-radiation environments. In addition, existing brute-force approaches for detecting and mitigating susceptibilities to a single event upset (SEU) and a single event functional interrupt (SEFI) have several disadvantages such as lower efficiency per processor and unusable system processing capacity.

### SUMMARY

Embodiments of the present invention address problems with determining single event fault tolerance in an electronic circuit and will be understood by reading and studying the following specification. Particularly, in one embodiment, a system for tolerating a single event fault in an electronic circuit is provided. The system includes a main processor that controls the operation of the system, a fault detection processor (e.g., an application-specific integrated circuit or ASIC) responsive to the main processor, and three or more field programmable logic devices (e.g., three or more FPGAs) responsive to the fault detection processor. The three or more programmable logic devices periodically issue independent input signals to the fault detection processor for determination of one or more single event fault conditions.

### DRAWINGS

FIG. 1 is a block diagram of an embodiment of an electronic system with a fault tolerant computing system according to the teachings of the present invention;

FIG. 2 is a block diagram of an embodiment of a circuit for detecting single event fault conditions according to the teachings of the present invention;

FIG. 3 is a block diagram of an embodiment of a programmable logic interface for detecting single event fault conditions according to the teachings of the present invention; and

FIG. 4 is a flow diagram illustrating an embodiment of a method for tolerating a single event fault in an electronic circuit according to the teachings of the present invention.

Like reference numbers and designations in the various drawings indicate like elements.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical, and electrical changes may be made without departing from the spirit and scope of the present invention. The following detailed description is, therefore, not to be taken in a limiting sense.

Embodiments of the present invention address problems with determining single event fault tolerance in an electronic circuit and will be understood by reading and studying the following specification. Particularly, in one embodiment, a system for tolerating a single event fault in an electronic circuit is provided. The system includes a main processor that controls the operation of the system, a fault detection processor responsive to the main processor, and three or more programmable logic devices responsive to the fault detection processor. The three or more programmable logic devices periodically issue independent input signals to the fault detection processor for determination of one or more single event fault conditions.

Although the examples of embodiments in this specification are described in terms of determining single event fault tolerance for high-reliability applications, embodiments of the present invention are not limited to determining single event fault tolerance for high-reliability applications. Embodiments of the present invention are applicable to any fault tolerance determination activity in electronic circuits that requires a high level of reliability. Alternate embodiments of the present invention utilize external triple modular component redundancy (TMR) with three or more programmable logic devices operated synchronously with one another. When one or more single event faults detected in one of the devices sufficiently exceeds an adjustable threshold, the device is automatically reconfigured and the three or more devices are resynchronized within a minimum allowable time frame.

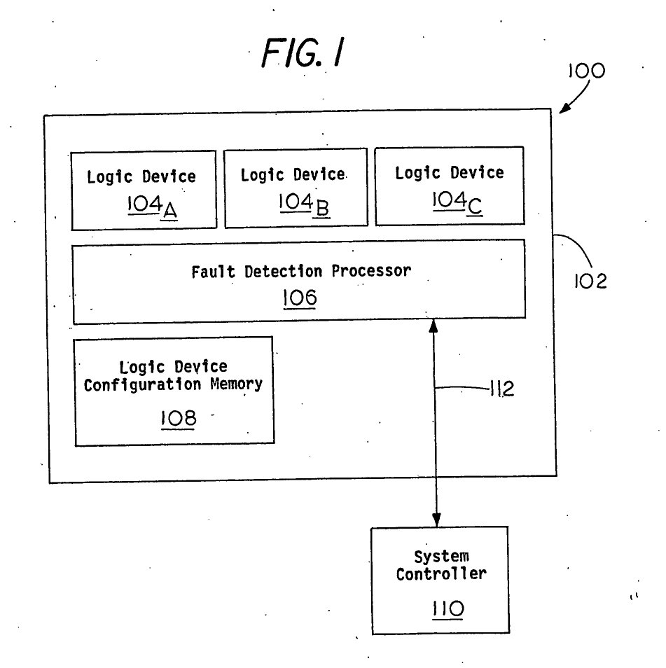

FIG. 1 is a block diagram of an embodiment of an electronic system, indicated generally at 100, with a fault tolerant computing system according to the teachings of the present invention. System 100 includes fault detection processor assembly 102 and system controller 110. Fault detection processor assembly 102 also includes logic devices 104_{A} to 104_{C}, fault detection processor 106, and logic device configuration memory 108, each of which are discussed below. It is noted that for simplicity in description, a total of three logic devices 104_{A} to 104_{C} are shown in FIG. 1. However, it is understood that fault detection processor assembly 102 supports any appropriate number of logic devices 104 (e.g., three or more logic devices) in a single fault detection processor assembly 102.

Fault detection processor 106 is any programmable logic device (e.g., an ASIC), with a configuration manager, the ability to host TMR voter logic, and an interface to provide at least one output to a distributed processing application system controller, similar to system controller 110. TMR requires each of logic devices 104_{A} to 104_{C} to operate synchronously with respect to one another. Control and data signals from each of logic devices 104_{A} to 104_{C} are voted against each other in fault detection processor 106 to determine the legitimacy of the control and data signals. Each of logic devices 104_{A} to 104_{C} are programmable logic devices such as a field-programmable gate array (FPGA), a complex programmable logic device (CPLD), a field-programmable object array (FPOA), or the like.

System 100 can form part of a larger distributed processing application (not shown) using multiple processor assemblies similar to fault detection processor assembly 102. Fault detection processor assembly 102 and system controller 110 are coupled for data communications via distributed processing application interface 112. Distributed processing application interface 112 is a high speed, low power data transmission interface such as Low Voltage Differential Signaling (LVDS), a high-speed serial interface, or the like. Also, distributed processing application interface 112 transfers at least one set of default configuration software machine-coded instructions for each of logic devices 104_{A} to 104_{C} from system controller 110 to fault detection processor 106 for storage in logic device configuration memory 108. Logic device configuration memory 108 is a double-data rate synchronous dynamic read-only memory (DDR SDRAM) or the like.

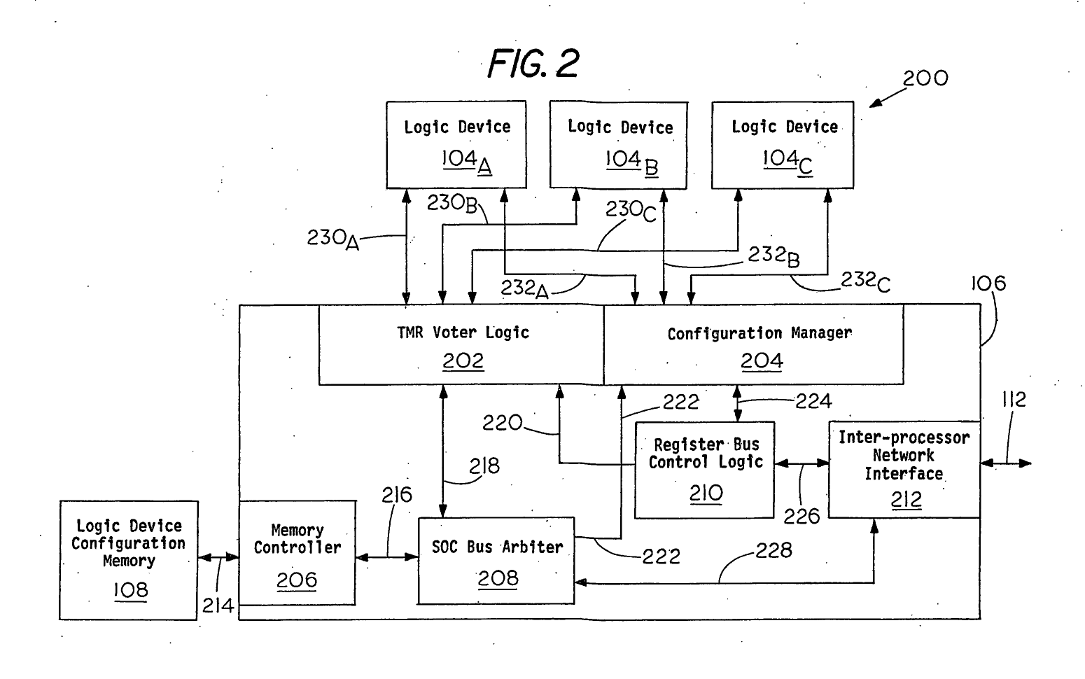

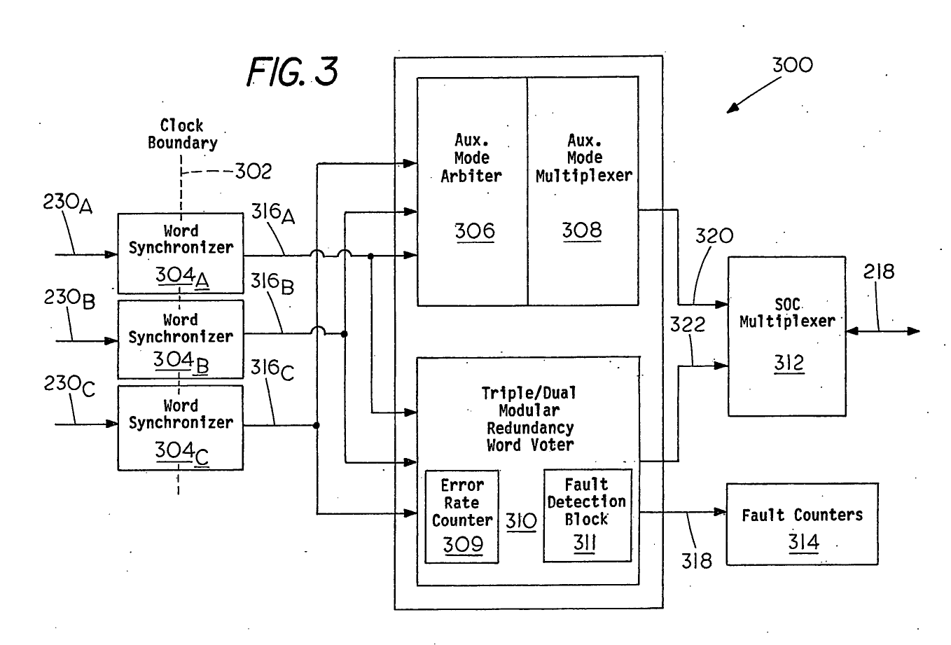

In operation, logic device configuration memory 108 is loaded during initialization with the at least one set of default configuration software machine-coded instructions. Fault detection processor 106 continuously monitors each of logic devices 104₁ to 104₃ for one or more single event fault conditions. The monitoring of one or more single event fault conditions is accomplished by TMR voter logic 202, and described in further detail below with respect to FIGS. 2 and 3. In the event that a sufficient number of single event fault conditions are detected by fault detection processor 106 (i.e., one of logic devices 104₁ to 104₃ has been identified as suspect), system controller 110 automatically coordinates a backup of state information currently residing in the faulted logic device and begins a reconfiguration sequence. The reconfiguration sequence is described in further detail below with respect to FIG. 2. Once the faulted logic device is reconfigured, or all three of logic devices 104₁ to 104₃ are reconfigured, system controller 110 interrupts the operation of all three logic devices 104₁ to 104₃ to bring each of logic devices 104₁ to 104₃ back into synchronous operation.

FIG. 2 is a block diagram of an embodiment of a circuit, indicated generally at 200, for detecting single event fault conditions according to the teachings of the present invention. Circuit 200 includes fault detection processor 106 of FIG. 1 (e.g., a radiation-hardened ASIC). Fault detection processor 106 includes TMR voter logic 202, configuration manager 204, memory controller 206, system-on-chip (SOC) bus arbiter 208, register bus control logic 210, and inter-processor network interface 212, each of which are discussed below. Circuit 200 also includes logic devices 104_{A} to 104_{C}, each of which is coupled for data communications to fault detection processor 106 by device interface paths 230_{A} to 230_{C}, respectively. Each of device interface paths 230_{A} to 230_{C}, are composed of a high-speed, full duplex communication interface for linking each of logic devices 104_{A} to 104_{C} with TMR voter logic 202. Each of logic devices 104_{A} to 104_{C} is further coupled to fault detection processor 106 by configuration interface paths 232_{A} to 232_{C}, respectively. Each of configuration interface paths 232_{A} to 232_{C} is composed of a full duplex communication interface used for configuring each of logic devices 104_{A} to 104_{C} by configuration manager 204. It is noted that for simplicity in description, a total of three logic devices 104_{A} to 104_{C}, three device interface paths 230_{A} to 230_{C}, and three configuration interface paths 232_{A} to 232_{C} are shown in FIG. 2. However, it is understood that circuit 200 supports any appropriate number of logic devices 104 (e.g., three or more logic devices), device interface paths (e.g., three or more device interface paths), and configuration interface paths (e.g., three or more configuration interface paths) in a single circuit 200.

TMR voter logic 202 and configuration manager 204 are coupled for data communications to register bus control logic 210 by voter logic interface 220 and configuration manager interface 224. Voter logic interface 220 and configuration manager interface 224 are bi-directional communication links used by fault detection processor 106 to transfer commands between control registers within TMR voter logic 202 and configuration manager 204. Register bus control logic 210 provides system controller 110 of FIG. 1 access to one or more control and status registers inside configuration manager 204. Register bus 226 provides a bi-directional, inter-processor communication interface between register bus control logic 210 and inter-processor network interface 212. Inter-processor network interface 212 connects fault detection processor 106 to system controller 110 via distributed processing application interface 112. Inter-processor network interface 212 provides a signal on distributed processing application interface 112 to indicate the occurrence of a sufficient amount of single event faults to system controller 110. As described above with respect to FIG. 1, distributed processing application interface 112 transfers at least one set of default configuration software machine-coded instructions to fault detection processor 106 for storage in logic device configuration memory 108. Logic device configuration memory 108 is accessed by memory controller 206 via device memory interface 214. Device memory interface 214 provides a high-speed, bi-directional communication link between memory controller 206 and logic device configuration memory 108.

Memory controller 206 receives the at least one set of default programmable logic for storing in logic device configuration memory 108 via bus arbiter interface 228, SOC bus arbiter 208, and memory controller interface 216. Bus arbiter interface 228 provides a bi-directional, inter-processor communication interface between SOC bus arbiter 208 and inter-processor network interface 212. SOC bus arbiter 208 transfers memory data from and to memory controller 206 via memory controller interface 216. Memory controller interface 216 provides a bidirectional, inter-processor communication interface between memory controller 206 and SOC bus arbiter 208. The set of default configuration software machine-coded instructions discussed above with respect to logic device configuration memory 108 is used to reconfigure each of logic devices 104₁ to 104₃. SOC bus arbiter 208 provides access to memory controller 206 based on instructions received from TMR voter logic 202 on voter logic interface 218. Voter logic interface 218 provides a bi-directional, inter-processor communication interface between TMR voter logic 202 and SOC bus arbiter 208. SOC bus arbiter 208 is further communicatively coupled to configuration manager 204 via configuration interface 222. Configuration interface 222 provides a bi-directional, inter-processor communication interface between configuration manager 204 and SOC bus arbiter 208. The primary function of SOC bus arbiter 208 is to provide equal access to memory controller 206 and logic device configuration memory 108 between TMR voter logic 202 and configuration manager 204.

In operation, configuration manager 204 performs several functions with minimal interaction from system controller 110 of FIG. 1 after an initialization period. System controller 110 also programs one or more registers in configuration manager 204 with a location and size of the set of default configuration software machine-coded instructions discussed earlier. Following initialization, configuration manager 204 is commanded to either simultaneously configure all three logic devices 104_{A} to 104_{C} in parallel or to individually configure a single logic device from one of logic devices 104_{Z} to 104_{C} based on results provided by TMR voter logic 202. After a sufficient number of single event faults have been detected by TMR voter logic 202, TMR voter logic 202 generates a TMR fault pulse. When the TMR fault pulse is detected by configuration manager 204, configuration manager 204 automatically initiates a sequence of commands to the one of logic devices 104_{A} to 104_{C} that has been determined to be at fault by TMR voter logic 202. For instance, if logic device 104_{B} is identified to be suspect, configuration manager 204 instructs logic device 104_{B} to abort. The abort instruction clears any errors that have been caused by one or more single event faults, such as an SEU or an SEFI. Configuration manager 204 issues a reset command to logic device 104_{B}, which halts operation of logic device 104_{B}. Next, configuration manager 204 issues an erase command to logic device 104_{B}, which clears all memory registers residing in logic device 104_{B}. Once logic device 104_{B} has cleared all the memory registers, logic device 104_{B}, in turn, responds back to configuration manager 204. Configuration manager 204 transfers the set of default configuration software machine-coded instructions for logic device 104_{B} from a programmable start address in logic device configuration memory 108 to logic device 104_{B}. Once the transfer is completed, configuration manager 204 notifies system controller 110 that a synchronization cycle must be performed to bring each of logic devices 104_{A} to 104_{C} back into synchronization. Only the one of logic devices 104_{A} to 104_{C} that has been determined to be at fault requires reconfiguration, minimizing system restart time.

FIG. 3 is a block diagram of an embodiment of a programmable logic interface, indicated generally at 300, for detecting single event fault conditions according to the teachings of the present invention. Logic interface 300 includes word synchronizers 304_{A} to 304_{C}, auxiliary mode arbiter 306, auxiliary mode multiplexer 308, triple/dual modular redundancy (TMR/DMR) word voter 310, SOC multiplexer 312, and fault counters 314, each of which are discussed below. Logic interface 300 is composed of an input section of TMR voter logic 202 as described above with respect to FIG. 2. It is noted that for simplicity in description, a total of three word synchronizers 304_{A} to 304_{C} are shown in FIG. 3. However, it is understood that logic interface 300 supports any appropriate number of word synchronizers 304 (e.g., three or more word synchronizers) in a single logic interface 300.

Each of word synchronizers 304_{A} to 304_{C} receive one or more original input signals from each of device interface paths 230_{A} to 230_{C}, respectively, as described above with respect to FIG. 2. Each of the one or more original inputs signals includes a clock signal in addition to input data and control signals from each of logic devices 104_{A} to 104_{C} of FIG. 2. Sending a clock signal relieves routing constraints and signal skew concerns typical of a high speed interface similar to that of device interface paths 230_{A} to 230_{C}. Each of word synchronizers 304_{A} to 304_{C} is provided the clock signal to sample the input data and control signals. The data and control signals are passed through a circular buffer inside a front end of each of word synchronizers 304_{A} to 304_{C} that aligns the input data and control signals on a word boundary with the frame signal. A word boundary is 20 bits wide (e.g., 16 bits of data plus 3 control signals and a clock signal), and 19 bits wide at each of synchronizer output lines 316_{A} to 316_{C}. Each of device interface paths 230_{A} to 230_{C} is routed with equal length to support voting on a clock cycle by clock cycle basis. After word alignment, aligned input data and control signals are transferred across clock boundary 302 and onto each of synchronizer output lines 316_{A} to 316_{C}. Each of synchronizer output lines 316_{A} to 316_{C} transfer synchronized outputs into a clock domain of fault detection processor 106 of FIG. 1. Each of synchronizer output lines 316_{A} to 316_{C} is coupled for data communication to both auxiliary mode arbiter 306 and TMR/DMR word voter 310. It is noted that for simplicity in description, a total of three synchronizer output lines 316_{A} to 316_{C} are shown in FIG. 3. However, it is understood that logic interface 300 supports any appropriate number of synchronizer output lines 316 (e.g., three or more synchronizer output lines) in a single logic interface 300.

In an exemplary embodiment, the synchronized outputs from logic devices 104_{A} to 104_{C} are transferred into TMR/DMR word voter 310. TMR/DMR word voter 310 incorporates combinational logic to compare each synchronized output from one of logic devices 104_{A} to 104_{C} against corresponding synchronized outputs from a remaining two of logic devices 104_{A} to 104_{C}. When two of three corresponding synchronized outputs are a logic one (zero), TMR/DMR word voter 310 produces a one (zero). Fault detection block 311 inside TMR/DMR word voter 310 determines which of logic devices 104_{A} to 104_{C} is miscomparing (i.e., disagreeing). An output pattern from fault detection block 311 contains three signals of all 1's if each of logic devices 104_{A} to 104_{C} is in agreement. If one of logic devices 104_{A} to 104_{C} miscompares, two signals within the output pattern will be logic zero. The two signals that agree (i.e., are each zero) cause a remaining signal to remain a logic one. The two agreeing logic devices of logic devices 104_{A} to 104_{C} continue to operate in a self-checking pair (SCP) or DMR mode. Once one of the logic devices 104_{A} to 104_{C} is determined to be at fault, miscompares between the two remaining logic devices of logic devices 104_{A} to 104_{C} in SCP mode signal a fatal error. In this embodiment, system controller 110, as described with respect to FIG. 1, begins a complete recovery sequence on all three of logic devices 104_{A} to 104_{C}. TMR/DMR word voter 310 is also coupled to cumulative error counter 314 that gathers statistics on the SEU or SEFI rate of the interface (e.g., over the life of a space mission). Cumulative error counter 314 does not determine a faulty logic device. Error-rate counter 309 determines when more than an acceptable number of miscompares have occurred sequentially.

In a different embodiment, the synchronized outputs contain an instruction from one of logic devices 104_{A} to 104_{C} to inform TMR voter logic 202 to switch into auxiliary mode. Moreover, auxiliary mode does not incorporate the features of triple modular redundancy as described in the present application. In an auxiliary mode, the synchronized outputs from each of logic devices 104_{A} to 104_{C} is transferred into auxiliary mode arbiter 306 to compete for eventual access to the inter-processor SOC bus along voter logic interface 218. Auxiliary mode multiplexer 308 selects which of the synchronized outputs from a selected logic device (i.e., one of logic devices 104_{A} to 104_{C}) is routed to SOC multiplexer 312 along auxiliary mode output interface 320.

Once it is determined which of logic devices 104_{A} to 104_{C} has been substantially modified by one or more single event faults, a reconfigure request is made to SOC bus arbiter 208 via TMR/DMR voter output interface 322 and SOC multiplexer 312. SOC multiplexer 312 selects the affected logic device of logic devices 104_{A} to 104_{C} for access to the SOC bus along voter logic interface 218. Once the affected logic device is granted access, reconfiguration of the affected logic device is handled automatically by configuration manager 204 of fault detection processor 106 as described with respect to FIG. 2 above. The word synchronization provided by each of word synchronizers 304_{A} to 304_{C} compensates for clock cycle delays between any of logic devices 104_{A} to 104_{C}. This provides TMR/DMR word voter 310 with completely synchronized data.

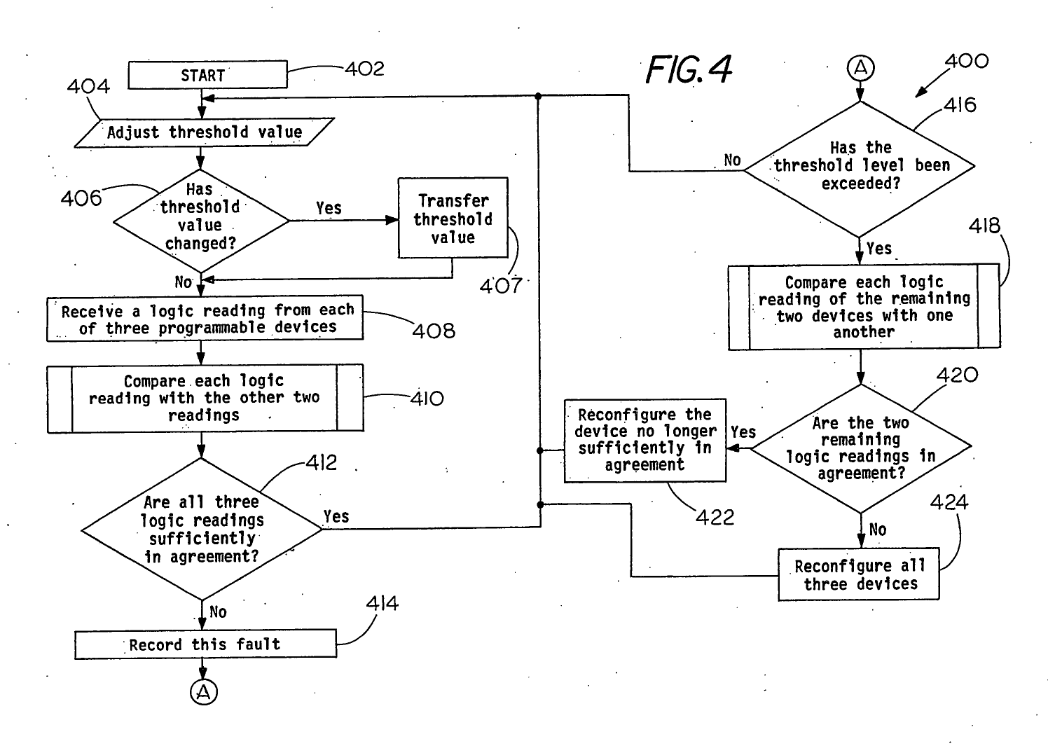

FIG. 4 is a flow diagram illustrating a method 400 for tolerating a single event fault in an electronic circuit, in accordance with a preferred embodiment of the present invention. The method of FIG. 4 starts at step 402. Once a threshold value is established (or adjusted) at step 404, method 400 begins the process of monitoring three or more programmable logic devices in the electronic circuit for a possible corruption due to an occurrence of a single event fault. A primary function of method 400 is to automatically reconfigure a corrupted programmable logic device within a minimum amount of time. Each of the three or more programmable logic devices must be substantially functional, with minimal downtime, to maintain a sufficient fault tolerance level in the electronic circuit.

At step 406, a determination is made about whether the adjusted threshold level needs to be changed from a previous or default level. This determination is made in the system controller described above with respect to FIG. 1. If the adjusted threshold level needs to change, the method proceeds to step 407. At step 407, the method begins transferring the threshold level from the system controller, and proceeds to step 408. If the adjusted threshold level has not changed, or the threshold level was fixed at a predetermined level, the method continues at step 408.

At step 408, the method receives a logic reading from each of the three or more programmable logic devices in the electronic circuit. Once each of the three or more logic readings are obtained, the method proceeds to step 410. At step 410, each of the three or more logic readings received is compared with at least other two readings. Once the comparison is made, the method proceeds to step 412. At step 412, the method determines whether all of the three or more logic readings are sufficiently in agreement. Determining whether all of the three or more logic readings are sufficiently in agreement involves determining which of the three or more programmable devices changed state. When all of the three or more logic readings are sufficiently in agreement, the method returns to step 404. When one of the three or more logic readings is not in agreement with the at least remaining two, the method proceeds to step 414. When one of the three logic readings is not in agreement with the at least remaining two, a single event fault has been detected. At step 414, the method updates an error rate counter to indicate that at least one additional single event fault has occurred before proceeding to step 416. The error-rate counter determines when more than an acceptable number of disagreeing logic readings has occurred sequentially. At step 416, the method determines whether the detection of the at least one additional single event fault has caused the error-rate counter to exceed the threshold level. If the threshold level is exceeded, the method proceeds to block 418. If the threshold level is not exceeded, the method returns to step 404.

At this point, the at least two remaining logic devices compensate for the one of the three or more logic readings not in agreement. At step 418, each logic reading of the at least remaining two logic devices is compared with each another before the method proceeds to step 420. At step 420, the method determines whether the at least two remaining logic readings are sufficiently in agreement with each another. If the at least two remaining logic readings are sufficiently in agreement with each another, the method proceeds to step 422. At step 422, a first logic device that was determined not to be sufficiently in agreement with the at least two remaining logic devices is automatically reconfigured. Otherwise, if the method determines at block 420 that the at least two remaining logic readings are not in agreement with each another, each of the three or more logic devices is automatically reconfigured at block 424. If method 400 reaches step 424, it signals to system 100 of FIG. 1 that a fatal or SCP error has occurred. Once the first logic device that was determined not to be sufficiently in agreement with the at least two remaining logic devices is automatically reconfigured in step 422, or each of the three or more logic devices are automatically reconfigured at step 424, the method returns to step 404.

The description of the present invention has been presented for purposes of illustration and description, and is not intended to be exhaustive or limited to the invention in the form disclosed. Many modifications and variations will be apparent to those of ordinary skill in the art. These embodiments were chosen and described in order to best explain the principles of the invention, the practical application, and to enable others of ordinary skill in the art to understand the invention for various embodiments with various modifications as are suited to the particular use contemplated.

1. A system for tolerating a single event fault in an electronic circuit, comprising:
a main processor that controls the operation of the system;
a fault detection processor responsive to the main processor;
three or more programmable logic devices responsive to the fault detection processor; and
wherein the three or more programmable logic devices periodically issue independent input signals to the fault detection processor for determination of one or more single event fault conditions.

2. The system of claim 1, wherein the main processor is further adapted to interface with at least one memory device.

3. The system of claim 2, wherein the at least one memory device is a double-data rate synchronous dynamic read-only memory.

4. The system of claim 1, wherein the fault detection processor is one of an application-specific integrated circuit, a microcontroller, and a programmable logic device.

5. The system of claim 1, wherein the three or more programmable logic devices are three or more of a field-programmable gate array, a complex programmable logic device, and a field-programmable object array.

6. The system of claim 1, wherein determination of one or more single event fault conditions further comprises:
reconfiguration of one of the three or more programmable logic devices that indicates a sufficient occurrence of one or more single event fault conditions; and
resynchronization of the three or more programmable logic devices.

7. The system of claim 6, wherein reconfiguration of the one of the three or more programmable logic devices further comprises a transfer of at least one set of default configuration software machine-coded instructions from the fault detection processor to the logic device.

8. A circuit for detecting one or more sufficient single event fault conditions, the circuit comprising:
means for generating a decision based on one or more logic readings provided by each of the one or more input signals;
means, responsive to the means for generating, for indicating whether at least one of the one or more input signals is affected by the one or more sufficient single event fault conditions; and
means, responsive to the means for indicating, for automatically reconfiguring the means for generating affected by the one or more sufficient single event fault conditions.

9. The circuit of claim 8, wherein the means for generating further includes three or more programmable logic devices.

10. The circuit of claim 9, wherein the three or more programmable logic devices are three or more of a field-programmable gate array, a complex programmable logic device, and a field-programmable object array.

11. The circuit of claim 8, wherein the means for indicating further includes a decision from at least one set of external triple modular redundancy voting logic.

12. The circuit of claim 8, wherein the means for automatically reconfiguring the means for providing further includes a configuration manager of an external fault detection processor.

13. A device for comparing one or more electronic signals, comprising:
voter logic that provides a first output signal to a multiplexer and a second output signal to one or more fault counters;
three or more word synchronizers that receive the one or more electronic signals and provide three or more adjusted outputs to the voter logic whereby the three or more adjusted outputs each provide a reading that the voter logic determines to be sufficiently in agreement; and
if one of the three or more adjusted outputs is not sufficiently in agreement with two or more remaining adjusted outputs, the device automatically reconfigures a source of the one of the three or more adjusted outputs not sufficiently in agreement.

14. The device of claim 13, wherein the device is one of an application-specific integrated circuit, a microprocessor, and a programmable logic device.

15. The device of claim 13, wherein the one or more fault counters further comprises one or more cumulative error counters that generate statistics on one or more occurrences of single event fault conditions over a specific time period.

16. The device of claim 13, wherein the three or more word synchronizers further comprise alignment of the one or more electronic signals to support comparisons made by the voter logic circuit on a periodic basis.

17. The device of claim 13, wherein the source of the one of the three or more adjusted outputs not sufficiently in agreement is a programmable logic device.

18. The device of claim 17, wherein the programmable logic device is one of a field-programmable gate array, a complex programmable logic device, and a field-programmable object array.

19. A method for tolerating a single event fault in an electronic circuit, comprising the steps of:
periodically receiving a logic reading from each of three or more programmable logic devices;
identifying a suspect device when the logic reading from the suspect device is no longer sufficiently in agreement with at least two logic readings that correspond to at least two remaining programmable logic devices;
comparing an adjustable threshold level to a number of times the three or more programmable logic devices have not been sufficiently in agreement; and
if the adjustable threshold level is exceeded, automatically reconfiguring the suspect device within a minimum amount of time.

20. The method of claim 19, wherein the step of periodically receiving the logic reading from each of the three or more programmable logic devices further comprises determining when one of the three or more programmable logic devices changes state.

21. The method of claim 19, wherein the step of comparing an adjustable threshold level to a number of times the three or more programmable logic devices have not been sufficiently in agreement further comprises determining when more than an acceptable number of disagreeing logic readings have occurred sequentially.

22. The method of claim 19, wherein the step of automatically reconfiguring the suspect device further comprises maintaining a sufficient level of reliability in the electronic circuit.

23. The method of claim 22, wherein the step of maintaining a sufficient level of reliability in the electronic circuit further comprises:
automatically compensating for the suspect device; and
if the at least two remaining programmable logic devices are no longer in agreement, automatically reconfiguring the at least two remaining programmable logic devices along with the suspect device.

24. A method for synchronizing data during one or more single event fault conditions, comprising the steps of:
routing one or more original input signals through a voter logic circuit;
aligning each of the one or more original input signals with a frame signal;
transferring an aligned input signal into a known time domain within the voter logic circuit; and
determining if the aligned input signal has been substantially modified by the one or more single event fault conditions.

25. The method of claim 24, wherein the one or more original input signals further comprise a control signal and a data signal.

26. The method of claim 24, wherein the one or more original input signals are of equal length.

27. The method of claim 24, wherein the step of aligning each of the one or more original input signals with the frame signal further comprises passing each of the one or more original input signals through a circular buffer.

28. The method of claim 24, wherein the step of determining if the aligned input signal has been substantially modified by the one or more single event fault conditions further comprises the steps of:
comparing an adjustable threshold level once every clock cycle in the known time domain to a number of times the aligned input signal has not been sufficiently in agreement; and
if the adjustable threshold level is exceeded, automatically reconfiguring a programmable logic device that generates the aligned input signal.

29. The method of claim 28, wherein the programmable logic device that generates the aligned input signal is one of a field-programmable gate array, a complex programmable logic device, and a field-programmable object array.
